(19) United States
(12) Patent Application Publication
(10) Pub. No.: US 2014/0174998 A1
(43) Pub. Date: Jun. 26, 2014

(54) FILTRATION ASSEMBLY INCLUDING MULTIPLE MODULES SHARING COMMON HOLLOW FIBER SUPPORT

(71) Applicants: Peter E. Aerts, Hulst (NL); Scott T. Burr, Midland, MI (US); Steven J. Gluck, Lake Jackson, TX (US); Chengfeng Wang, Huzhou (CN)

(72) Inventors: Peter E. Aerts, Hulst (NL); Scott T. Burr, Midland, MI (US); Steven J. Gluck, Lake Jackson, TX (US); Chengfeng Wang, Huzhou (CN)

(73) Assignee: Dow Global Technologies LLC, Midland, MI (US)

(21) Appl. No.: 14/125,189

(22) PCT Filed: Aug. 1, 2012
(86) PCT No.: PCT/US2012/049088

§ 371 Date: Dec. 10, 2013

Related U.S. Application Data
(60) Provisional application No. 61/556,316, filed on Nov. 7, 2011.
(60) Provisional application No. 61/526,539, filed on Aug. 23, 2011.

(51) Int. Cl. B01D 63/04

(52) U.S. Cl. CPC B01D 63/04
USPC 210/151; 210/321.9

(57) ABSTRACT

A filtration assembly comprising a first and second module, each module comprising a plurality of vertically aligned semi-permeable hollow fiber membranes extending along a length between first and second ends with one of said ends potted within a header, and wherein the headers of the modules are aligned and spaced apart to define a vertical flow path; and at least one fiber support positioned along the length of the hollow fiber membranes of both modules, wherein the fiber support comprises a frame including a plurality of partitions that segment the hollow fiber membranes of both modules into common fiber groupings passing through the fiber support.

### TECHNICAL FIELD

The present invention is directed toward filtration assemblies including semi-permeable hollow fiber membranes. Representative applications for such devices include purification of water from streams, rivers, ponds and lakes. Additional applications include the treatment of municipal and industrial waste water including sewage and settling ponds. Such filtration assemblies may also find use in membrane bioreactor (MBR) applications.

### BACKGROUND ART

Filtration modules commonly utilize semi-permeable hollow fiber (a.k.a. “capillary”) membranes. One classic design includes a plurality of hollow fibers extending between opposing headers. Specific examples are described in: U.S. Pat. Nos. 5,248,424, 6,214,226, 6,682,652 and 7,850,853. In an alternative design, one end of the hollow fiber membranes are potted within a header with the opposite ends unsupported and free to move. Examples of single header designs are described in U.S. Pat. No. 7,160,454, JP 11-342321 and JP 11-128692. In operation, several modules may be interconnected to form a filtration assembly which is submerged in a tank or module encasement having a feed liquid source such as a settling pond, an aerobic activated sludge basin or an anaerobic biological water treatment basin. Filtration occurs by creating a trans-membrane pressure differential across the membrane surface, i.e. typically by drawing a vacuum from the permeate side of the membrane or by pressurizing the feed source. As a result of trans-membrane pressure, permeate flows through the pores of the membranes and is collected within a header which is sealed from the feed source. After prolonged use, suspended solids from the feed liquid accumulate on the membrane surface and form a fouling or “cake” layer that restricts or even blocks fluid flow. Cake layers may be at least partially removed by aeration techniques wherein bubbles scour the outer surface of the membrane. Aeration and related turbulent flow can result in fiber breakage or entanglement. One approach for mitigating these effects is the use of a cage, web or netting that encircles one or more bundles of fibers and limits their range of motion. For example, U.S. Pat. No. 7,531,091 describes the use of a plurality of fiber holding devices (“fiber supports”) spaced along the length of hollow fiber membranes. Each module includes a fiber support that comprises a plurality of rectangular partitions that segment the fibers passing through. The partitions of each fiber support are vertically aligned with each other and collectively define adjacent vertical columns that encircle fiber bundles that extend upward from a common header. Additional examples are described in U.S. Pat. Nos. 6,783,008 and 7,160,454.

While the use of a fiber support mitigates fiber breakage during aeration, such supports limit the effectiveness of aeration by restricting fluid access within individual fiber bundles.

### STATEMENT OF INVENTION

The invention includes a filtration assembly comprising a first and second filtration module. Each module comprises a plurality of vertically aligned semi-permeable hollow fiber membranes extending along a length between first and second ends with one of the ends potted within a header. The headers of the first and second modules are aligned and spaced apart to define a vertical flow path. At least one fiber support is positioned along the length of the hollow fiber membranes of both modules. The fiber support comprises a frame including a plurality of partitions that segment the hollow fiber membranes of both modules into common fiber groupings which pass through the fiber support. Many additional embodiments are disclosed.

### BRIEF DESCRIPTION OF THE FIGURES

The included figures illustrate several embodiments of the subject assembly. The figures are not to scale and include idealized views to facilitate description. Where possible, like numerals have been used throughout the figures and written description to designate the same or similar features.

FIG. 1 is a perspective view of a filtration assembly comprising a first and second module (i.e. a “set”) which are aligned and spaced apart to define a vertical flow path.

FIG. 2 is a partially cut away perspective view of a filtration assembly showing two sets of modules configured as part of a rack system.

### DETAILED DESCRIPTION

While applicable to both dual and single header designs, the present invention is particularly applicable for single header designs wherein a plurality (typically hundreds) of hollow fiber membranes (“fibers”) are generally aligned along a common plane and potted (i.e. collectively sealed) at one end within a header. The technique for potting is not particularly limited but typically involves collectively sealing the ends of the fibers within a mass of potting material. Most commonly, potting is accomplished by embedding the ends of the fibers within a liquid sealant that subsequently hardens to form a tube sheet. The ends of the fibers are subsequently opened, e.g. by cutting through a section of the hardened potting material, or are otherwise temporarily sealed or protected such that liquid potting material is prevented from entering the ends of the fibers. A variety of applicable potting techniques and materials are described in the art, see for example: U.S. Pat. Nos. 3,708,071, 4,666,469, 5,192,478, 6,214,226, 6,290,756, 6,592,759, 6,974,554, 7,160,455, 7,344,645, 7,704,393 7,931,805, U.S. 2007/0158257 and U.S. Ser. No. 12/891,968.

The header design is not particularly limited but generally includes an elongated housing for receiving the potted end of the tube sheet and further includes an inner permeate chamber that is in fluid communication with the lumens of the fibers. The header further includes a passageway for permeate to exit the module. Examples are provided in the previously mentioned patent references.

The selection of fiber is not particularly limited but in general, each fiber comprises an elliptical (e.g. cylindrical) porous outer structure surrounding a lumen which extends between a first and second end. The dimension of the fibers is not particularly limited. Preferred dimensions include: an outer diameter of from about 0.5 to 5 mm, an inner diameter of from about 0.5 to 2 mm and a wall thickness (i.e. porous structure between the inner and outer diameters) of from about 0.1 to 2 mm. The length of the fibers is not particularly limited and is typically dependent upon the module design. Representative lengths include those from about 0.2 to 2 m. The type of semi-permeable hollow fiber membrane is not particularly limited. Representative examples include hollow fiber membranes prepared from polysulfones, polyether sulfones, polyvinylidene fluorides (PVDF) and polyamides, commonly prepared by way of well known phase inversion processes. Additional examples include membranes made from polyolefins such as polypropylene, polyethylene and related copolymers via known etching and stretching processes. The cylindrical porous structure of the fibers is not particularly limited and may include isotropic or anisotropic structures. In preferred embodiments, the fibers are suitable for micro and ultrafiltration applications, e.g. pore sizes of from about 0.001 to 10 μm but more preferably from 0.01 to 1 μm.

The subject filtration assembly comprises at least two but preferably from 2 to 50 individual modules. In a preferred embodiment, two modules are arranged as a set with their headers aligned and spaced apart (e.g. from 2 to 100 mm, but more preferably from 5 to 50 mm) to define a vertical flow path therebetween that extends upward along the length of the hollow fibers. The hollow fibers of the two adjacently positioned modules (i.e. a “set”) pass through at least one and preferably a plurality (e.g. 2-10) of fiber supports spaced apart and along the length of the fibers. Each fiber support comprises a frame including a plurality (e.g. 2-50, preferably 6-30) of partitions that segment the hollow fiber membranes of both modules into a plurality of common fiber groupings that pass through the fiber support. In a preferred embodiment, the frame is secured along the sides of the module and extends across the path of the fibers of both modules. The shape (e.g. rectangular, elliptical, etc.) and size of the partitions are not particularly limited, nor must the partitions be of equal size.

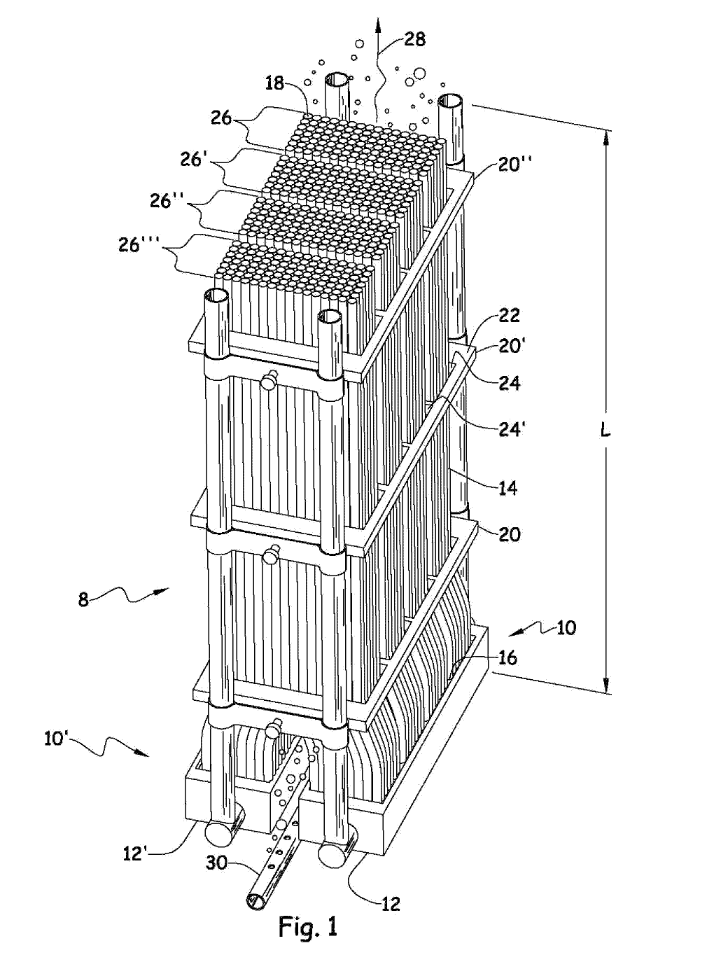

FIG. 1 illustrates an embodiment of the invention comprising a filtration assembly (8) including a first and second module (10, 10′), each including a header (12, 12′) with a plurality of vertically aligned fibers (14) extending upward along a length (L) between a lower first (16) end potted within the header (12/12′) and an upper second end (18) that is unrestrained. While not shown, the second ends of the fibers (14) are individually sealed. One or more fiber supports (20, 20′, 20″) are spaced apart along the length (L) of the fibers (14) between their first and second ends (16/18). Each fiber support (20, 20′, 20″) includes a frame (22) and a plurality of rectangular shaped partitions (24, 24′) that segment the fibers (14) into multiple fiber groupings (26, 26′, 26″, 26″′) passing therethrough. The headers (12/12′) are aligned and spaced apart from each other and define a vertical flow path (28) that extends upward. In the embodiment shown, an aerator pipe (30) is positioned below the space between the headers (12/12′) such that gas bubbles emitted from the aerator pipe (30) flow upward along the vertical flow path (28) within the common fiber groupings (26, 26′, 26″, 26″′).

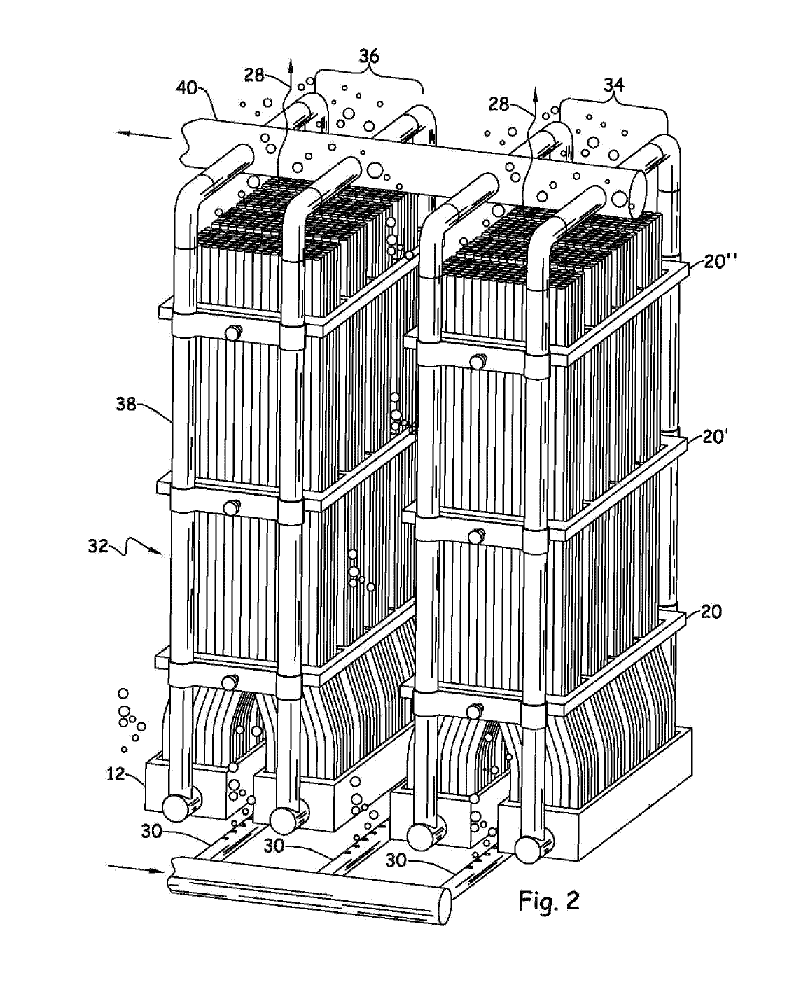

FIG. 2 illustrates a filtration assembly (32) including two sets of modules (34, 36) as part of a rack assembly. Each module is the same as that described with respect to FIG. 1. An aerator located below the modules includes multiple aerator pipes (30) that deliver bubbles that travel upward along vertical flow paths (28). Each header is in fluid communication with at least one permeate pipe (38). In the embodiment shown, the permeate pipe (38) extends vertically upward along the side of the module and is connected to a common permeate manifold (40) extending along the top of the rack system. Permeate from each header is removed from the assembly via the manifold (40). The gap space between the modules (34, 36) may be modified to effect vertical fluid flow between the modules, e.g. the gap space may be narrowed to reduce vertical fluid flow between the modules.

Preferred embodiments of the present invention improve the effectiveness of aeration by directing gas bubbles within common fiber groups of multiple modules. In doing so, bubbles are partially entrapped within the fiber group along a greater portion of their length (L).

While the focus of the description has been directed toward single header module designs, the subject invention is also applicable to multi-header designs along with filtration modules used in separation various fluids. By way of example, the invention is applicable to module designs wherein multiple headers are positioned adjacently to each other with hollow fiber membranes extending vertically upward to individually sealed ends and wherein the fibers from adjacent headers share common fiber supports along their length. By way of another example, the invention is also applicable to classic two header designs wherein hollow fibers extend between two opposing headers.

Many embodiments of the invention have been described and in some instances certain embodiments, selections, ranges, constituents, or other features have been characterized as being “preferred.” Characterizations of “preferred” features should in no way be interpreted as designated such features as being required, essential or critical to the invention. It will be understood that certain features and sub-combinations are of utility and may be employed without reference to other features and sub-combinations. References to ranges of numerical values expressly include the end points of such ranges. The entire subject matter of each patent document mentioned herein is incorporated by reference.

1. A filtration assembly comprising:
a first and second filtration module, each comprising a plurality of vertically aligned semi-permeable hollow fiber membranes extending along a length between first and second ends with one of said ends potted within a header, and wherein the headers of the first and second modules are aligned and spaced apart to define a vertical flow path; and
at least one fiber support positioned along the length of the hollow fiber membranes of both modules, wherein the fiber support comprises a frame including a plurality of partitions that segment the hollow fiber membranes of both modules into common fiber groupings passing through the fiber support.

2. The filtration assembly of claim 1 further comprising an aerator in fluid communication with said vertical flow path such that gas bubbles produced by the aerator flow along the vertical flow path between the headers of the first and second modules and along the common fiber groupings.
